(19) United States
(12) Patent Application Publication
(10) Pub. No.: US 2007/0139558 A1
(43) Pub. Date: Jun. 21, 2007

(54) Multifunctional appliance for audio/video signal processing

(75) Inventor: Andreas Reineke, Paderborn (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Medion AG, Essen (DE)

(21) Appl. No.: 10/568,820

(22) PCT Filed: Aug. 17, 2004
(86) PCT No.: PCT/EP04/09222

§ 371 Date: Nov. 17, 2006

(30) Foreign Application Priority Data
Aug. 19, 2003 (EP) 03018860.1

(51) Int. Cl. H04N 5/14

(52) U.S. Cl. 348/571

(57) ABSTRACT

The present invention relates to an audio/video signal processing apparatus that integrates a plurality of standard consumer electronic apparatuses into one apparatus in a compact manner. The integration of the plurality of apparatuses or applications in a housing with common use of different storage media enables new possibilities for use to be developed for the first time for a plurality of the applications. The uniform use of the storage media, the central processing unit, the electrical communication interface and the user interface can minimise the hardware expenditure and significantly improve the user-friendliness by means of a uniform user interface. The modular structure of the application functions enables cost-effective and flexible adaptation to novel technologies and standards. Furthermore, the apparatus configuration can be easily adapted to local conditions.

The present invention relates to a multi-functional apparatus for the processing of audio and video signals. In particular the present invention relates to an audio/video signal processing apparatus, which combines a plurality of different audio and video signal processing operations in one single device.

In recent years numerous new technical developments have become established on the market in the field of consumer electronics. This development is particularly attributable to the increasing digitisation in all the fields of consumer electronics. On the basis of new storage technologies and transmission methods, digitisation facilitates new entertainment services at more economical prices with simultaneously higher quality.

Although the new technologies offer the consumer a higher quality at lower prices and easier operation, they cannot completely replace the old technologies. In addition, there are no consumer electronic devices which can read the contents of the old data media and convert it into new digital formats and archive them. Nowadays, the consumer must therefore have ready side by side consumer electronic apparatuses of old and new technologies to be able to actually profit from the new possibilities without having to abandon existing data stocks. Additionally, with new technologies, often no universal standard is initially established, so that different variants of a new technology exist together in parallel. For this reason the consumer must nowadays keep a large number of different apparatuses at home, often even for the same application.

Whereas 20 years ago the consumer was completely equipped with a record player, cassette recorder, radio, television and video recorder, today the number of apparatuses has multiplied. The transition from analogue to digital television is still in its infancy. Therefore, the simultaneous possession of television apparatuses with analogue and digital television tuners/receivers is necessary. With the video and audio data recording apparatuses there exists a large variety of new and not so new technologies. With the optical storage media the compact disc (CD) and the DVD exist together, whereby the next generation of high density (HD)-DVD is already just prior to introduction. With the recording of data on these optical storage media there are incompatible standards available from different company consortiums. As a magnetic storage medium tape recording apparatuses are being more and more superseded on the market, whereas recording on magnetic disks in the form of hard disks and optical media such as CDs or DVDs is becoming increasingly established. Also, a large variety of standards for memory cards is arising. These memory cards are based on the flash memory technology which manages without mechanical components and is able to store a large amount of data in a small size. In particular this storage technology is used in digital photography and in the digital audio field. With the aid of memory cards image and audio data can be transported in a simple manner. It is only a question of time until the capacities of the flash memory modules are sufficient to also save video data.

The variety of devices mentioned has the disadvantage that the consumer must acquire a correspondingly large number of apparatuses if he wants to participate in the possibilities offered by the new technologies. Such a large number generally however extends beyond the space available at home. In addition, the consumer must in each case become familiar with the operation of each new apparatus and keep an additional control unit, generally a remote control unit, at hand.

Various approaches have previously been made in the solution of these problems. The problem of the large number of remote control units which are based on infrared transmission can be solved by so-called all-purpose remote control units. Such remote control units learn the infrared commands assigned to the individual apparatuses and operations in order to combine them in one single remote control unit. In this way however neither the problems of the sometimes very different operating concepts of the apparatuses nor the spatial problem is solved for the consumer. Additionally, special functions of some apparatuses are lost which are only obtainable via special keys.

To solve this problem other manufacturers have reduced the individual consumer electronic components noticeably in size and combined them to form “mini systems”. The complete system can be controlled with a remote control unit. Later adaptation to new technologies is however only possible in rare cases. Generally the system must be replaced as new.

Other manufacturers have integrated the individual consumer electronic apparatuses in part to one apparatus, for example, a radio receiver with an amplifier, sometimes also additionally combined with a CD player and/or a cassette recorder. Such combination apparatuses are however complicated to manufacture and even less easily adaptable to new technological developments and market demands.

The object of the present invention is to provide an audio/video processing apparatus which with a simple construction avoids the disadvantages mentioned above.

The object is solved by the features of claim 1.

Preferred embodiments of the present invention are the object of the subclaims.

The audio/video processing apparatus according to the present invention combines a number of different audio and/or video signal processing operations in one housing. The apparatus comprises a central unit, a control unit and a number of signal processing modules provided in a housing for audio/video signal processing operations. The central unit of the apparatus comprises a processor, an archiving device, a man-machine interface and an I/O communication interface. The processor executes audio and/or video signal computing operations for audio and/or video signals passed from a signal processing module in dependence of the computing operation requested by the signal processing module. The archiving device is used for storing audio and video signals. The man-machine interface contains a device for generating a display signal for visual user guidance for the audio and/or video signal processing operations of the plurality of signal processing modules, a device for the acquisition of user operations from the control unit for the control of the audio and/or video signal processing and a device for the appropriate driving of one of the plurality signal processing modules. The I/O communication interface can receive audio and/or video signals to be processed and output audio and/or video signals, including the display signal for the visual user guidance, on a reproduction device which can be connected to the I/O communication interface.

Conventional consumer electronic apparatuses are based on specialised hardware which in each case is only able to execute the individual consumer electronic apparatus functionality for which it has been developed. In contrast, the audio/video signal processing apparatus of the present invention is based on a powerful, non-specialised processor which, instead of a corresponding large number of specialised hardware devices, handles a plurality of audio and video computing operations. Due to this non-specialised hardware approach the computing power of the processor can serve all apparatuses made available in the audio/video processing apparatus. The approach of the present invention facilitates the integration of a wide range of different consumer electronic functionalities in a single apparatus.

In this way the present invention is able to realise a plurality of conventional consumer electronic apparatuses in a single apparatus with small dimensions. This is achieved in particular by a single user interface and a single central processing unit with an archiving device. With the aid of the modules that can be employed, the functions also required for the emulation of the respective consumer electronic apparatus are provided and the central processing unit is controlled appropriately. With the multi-purpose processing unit and a hardware and/or software addition appropriate to the respective consumer electronic application most consumer electronic apparatuses can be realised with the minimum of effort.

With the audio/video signal processing apparatus of the present invention also conventional interactions between various apparatuses can be realised in a simple manner. For example, a television signal received by a television module can be recorded on the archiving apparatus or recorded via a recording module on an optical disk. Since with this apparatus different audio and video signal processing operations are integrated in one apparatus in a previously unknown manner, completely new interactions between the signal processing modules can also be realised.

Apart from a minimum spatial requirement the present invention provides universal user guidance for the plurality of apparatuses. In particular the apparatus can be simply adapted to new technologies through the addition or exchange of a module. When doing this, the new functionality is automatically integrated into the existing user guidance. There is therefore no additional clarification requirement for the consumer during the integration of new consumer electronic functionalities.

Additionally, the user can integrate existing consumer electronic apparatuses in a simple manner via the analogue and/or digital interfaces into the audio/video signal processing system of the present invention.

All current standards can be processed with the aid of the modular structure of video and audio data.

The present invention thus facilitates an economical, space-saving and flexibly adaptable audio/video signal processing apparatus.

According to a preferred embodiment the I/O communication interface comprises connections for at least one of a plurality of different digital and analogue interface standards such as PCI, USB, SPDIF, Firewire, analogue audio in/out and analogue video in/out. The communication interface in this way integrates in a simple manner both external apparatuses, which the consumer wants to connect to the apparatus of the present invention, as well as the modules employed in the housing.

Preferably those connections of the I/O communication interface for a permanent apparatus connection are arranged on the back of the housing, whereas connections for an apparatus connection of only temporary duration are arranged on the front of the housing. In this way the number of connections on the front of the apparatus can be minimised without making it more difficult for the consumer to temporarily connect single external apparatus. In particular slots for memory cards are provided on the front of the apparatus.

The display signal for the visual user guidance represents a list of menu options for the operation of the multi-functional apparatus. Using this single-dimension selection list the user can in a simple way select the option he desires and in doing this, navigate through various hierarchical levels. In this way for example the consumer electronic apparatus to be realised by the apparatus of the present invention and its respective operation can be selected. Thus for example a television channel is selected when the television module is active. Such a single-dimensional selection can be understood by the user intuitively without the need for explanation. Using such a list, apparatuses, contents (images, MP3 files, TV channels), actions, settings, etc. can be selected.

To generate the display signal preferably an on-screen display is used. Using such an on-screen display, the menu options can be converted into a screen signal in a simple and economical manner.

One of the displayed menu options is selected via a control unit, which preferably is a remote control unit. For this purpose the remote control unit preferably contains a manually operable rotating wheel or manually operable scroll keys. In addition a selection key is provided with which the selected option can be activated. In this way the remote control unit can be operated with the thumb of one hand without the user having to turn his view away from the viewing monitor of the display signal to the remote control unit for the selection of the correct keys. Using the rotating wheel or the scroll keys the respective selected menu option can be varied in a simple manner and confirmed or activated with the selection key. A particularly easy operation can be achieved also by inexperienced users via the simply constructed control unit without a complicated keyboard or pointer device. Thus, those functionalities which are customarily not used by most users due to the awkwardness of operation can be brought to a large circle of users in a simple manner.

Due to the use of the same visual user guidance via single-dimensional menus for all modules that can be employed, the control of the multi-functional apparatus is intuitively understandable by the user and an additional need for explanation is not necessary, even with the integration of new apparatus.

The man-machine interface converts signals received by the control unit in dependence of the respectively active signal processing module into module-specific control commands. The information about the respectively active signal processing module is preferably saved in a status register. The uniform user guidance can thus be converted in a simple manner into the respective required control signals.

Preferably, the apparatus is fitted with a processor fan for the ventilation and appropriate cooling of the processor with air. The air drawn in by the processor fan is preferably fed to it from outside. The dissipated heat of all the components arranged in the multi-functional apparatus gives rise to an air temperature within the apparatus of about 10° C. above the outer temperature. Due to the feed of external air, an efficient cooling of the processor, the most taxed component in the apparatus, is obtained. Using these measures the required throughput of air can be reduced with the same cooling effect, preferably via a reduction in the rotational speed of the fan in order to maintain the generated noise at a low level.

Through the use of an air duct with a conical shape for blowing onto the processor, a processor fan with a large cross-section can be used for a processor with a small cross-section. Due to the larger fan cross-section, the same air throughput can be achieved with a lower rotational speed and therefore with lower noise generation.

There is an electronic speed control for the fan. The command variable is the CPU chip temperature. The fan control ensures that the fan only runs as fast as is necessary. It ensures that the CPU is not operated outside the limits of its thermal specification.

According to a preferred embodiment of the present invention the mechanical drives of the multi-functional apparatus are mounted on the housing via damping elements. This measure prevents vibrations being transferred to the housing. Such vibrations can be caused by the rotational motion and an imbalance in the moving masses in the drive. Due to the damping, vibrations cannot become annoying due to the housing acting as a resonator.

The damping elements are preferably made of rubber. In achieving this, the mechanical drives are preferably inserted into an accommodation receptacle of the housing via a plastic rail mounted on the mechanical drive, whereby the plastic rail is mounted on the drive via a rubber buffer. Through this simple measure the transfer of vibrations from the mechanical drives to the housing can be effectively suppressed, and especially in that there is no firm mechanical joint between the accommodation receptacle and the drive.

Preferably each prepared position for the accommodation of a module or a mechanical drive is formed according to a standard form factor. Through the similar design of all modules, the same can then be manufactured economically and are easily interchangeable—in particular for the adaptation to new technologies or standards.

The audio/video signal processing apparatus according to the present invention comprises a plurality of signal processing modules. Preferably a plurality of the following signal processing modules are integrated into the apparatus: a television module, a video data processing module, a CD/DVD module, an audio data processing module, a radio module, a photographic data processing module and a recording module. Through the combination of a plurality of modules in one single apparatus a large number of previously unknown interactions is possible between the individual processing operations. In particular the recording of audio and video signals, which can originate from all modules is possible in a simple manner. In contrast to conventional apparatuses, here a flexible selection of signal sources and recording medium is possible. In this respect, the hard disk provided in the central unit can be used additionally for intermediate storage or for archiving the data to be recorded.

With the television module an analogue and/or digital television module is involved. The analogue television module is set up for the reception of television signals according to at least one of the standards NTSC, PAL and SECAM. The television module is in particular responsible for the processing of analogue or digital television signals into MPEG-2 video signals. Through the individual application of different television modules, the apparatus can in a simple manner take into account the local circumstances of the television transmission. In particular the apparatus can thus be adapted in a simple way to the local level of conversion from analogue to digital television.

According to a preferred embodiment the audio/video signal processing apparatus comprises a module for high resolution television signals (HDTV).

Preferably television signals, which are transmitted analogue or digitally over satellite, cable or terrestrially, can be received with the television module(s).

The radio module is formed in a corresponding manner as an analogue or digital radio module. The apparatus can be adapted appropriately depending on the spread of the international DAB and DVB standards.

Preferably the audio/video signal processing apparatus according to the present invention comprises both an optical drive for the display of data recorded on CDs or DVDs as well as an optical drive for the recording of this data. In this way data from CDs and DVDs can be combined anew and archived on an optical recording medium. Alternatively, only one optical drive is used, which is used both for reading as well as for writing data. Copy processes can be carried out with the aid of the archiving device integrated into the apparatus.

Apart from an optical storage drive, the present invention comprises preferably also a magnetic storage drive, for example a further hard disk drive or a Minidisc drive. Due to the large number of drives, the flexibility for the reproduction and recording of data is particularly large.

The photographic processing module facilitates preferably the decoding, coding, editing and archiving of image data. Thus, processing one's own photographs in a simple manner at home is possible with the audio/video signal processing apparatus via one's own television or another display apparatus.

Preferred embodiments of the present invention are explained below in more detail with reference to the figures.

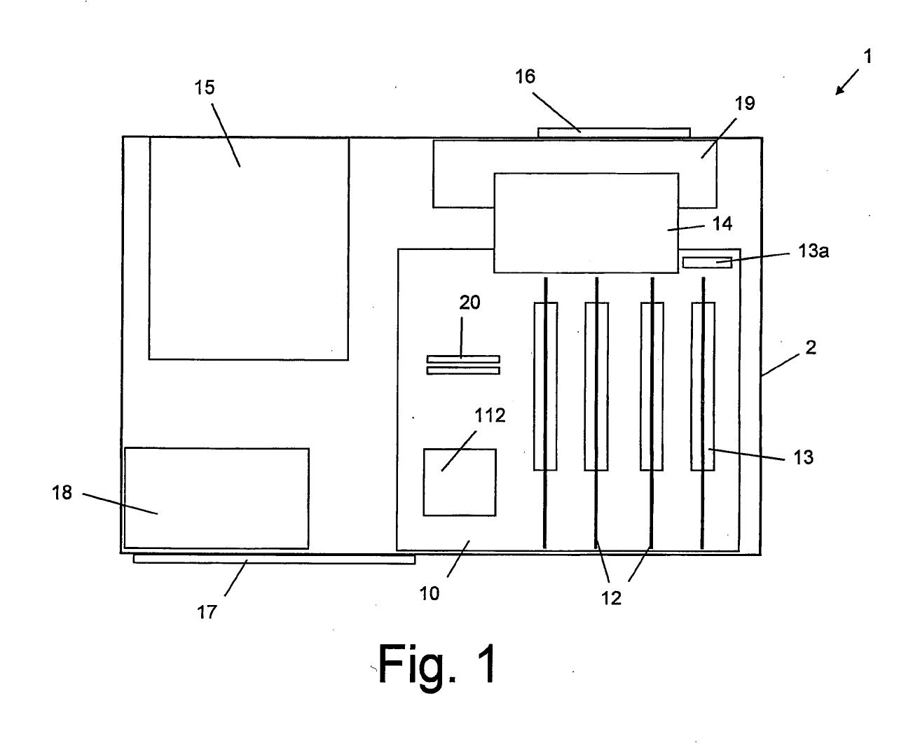

FIG. 1 shows a schematic view of the audio/video signal processing apparatus according to the present invention.

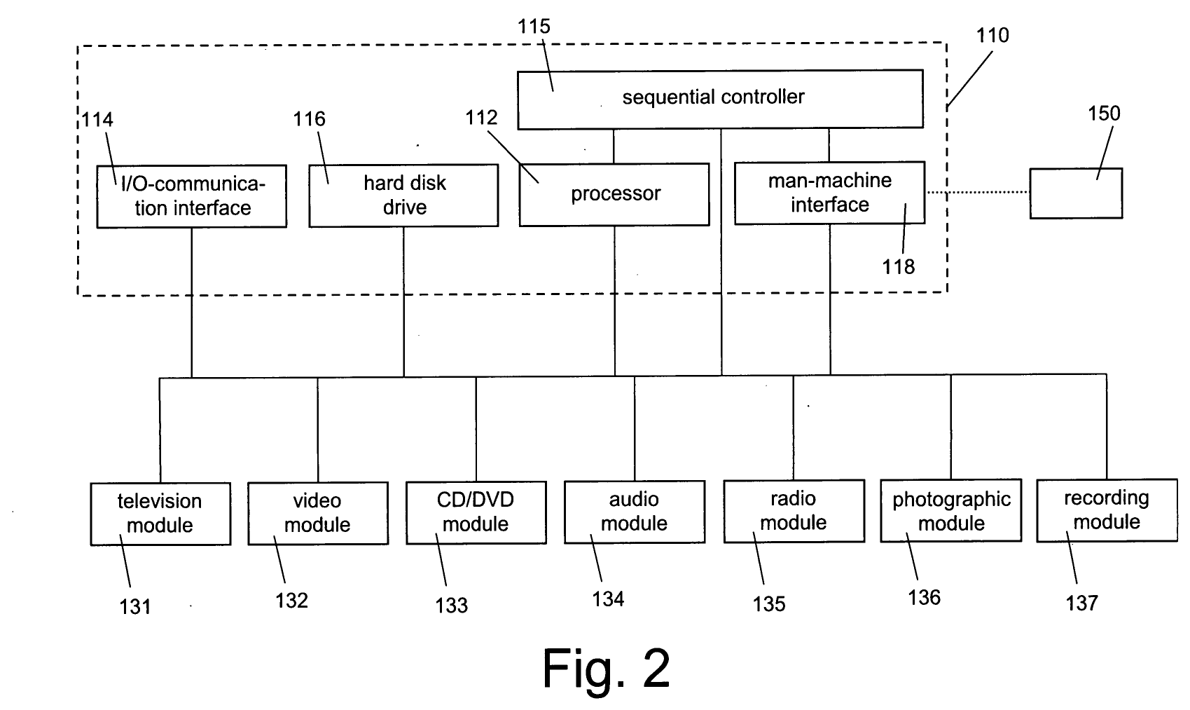

FIG. 2 shows in block diagram form the wiring of the individual components of the audio/video signal processing apparatus according to the present invention.

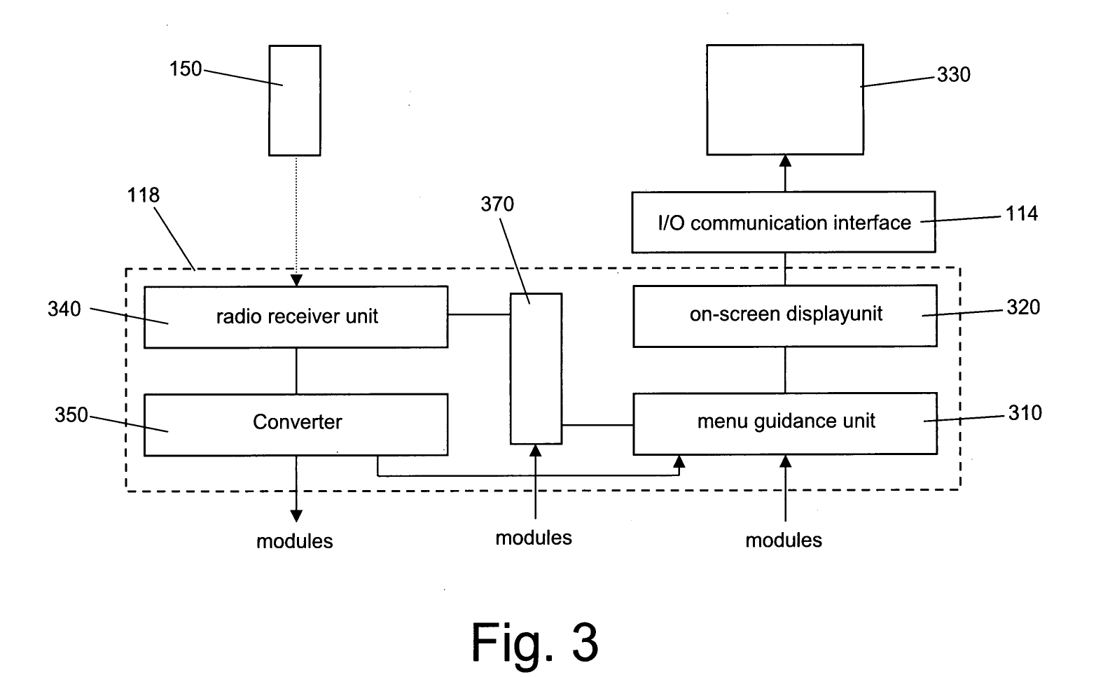

FIG. 3 shows in detail the construction of the man-machine interface of the audio/video signal processing apparatus according to the present invention.

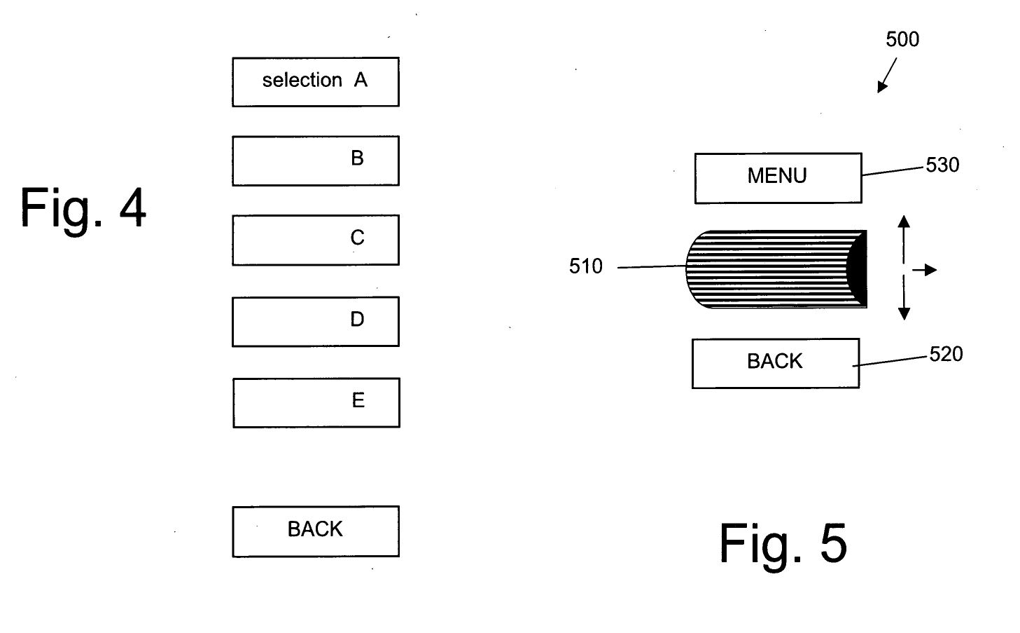

FIG. 4 shows a generalised example of a display for the user guidance according to the present invention.

FIG. 5 shows a detail of the control unit according to the present invention of the man-machine interface.

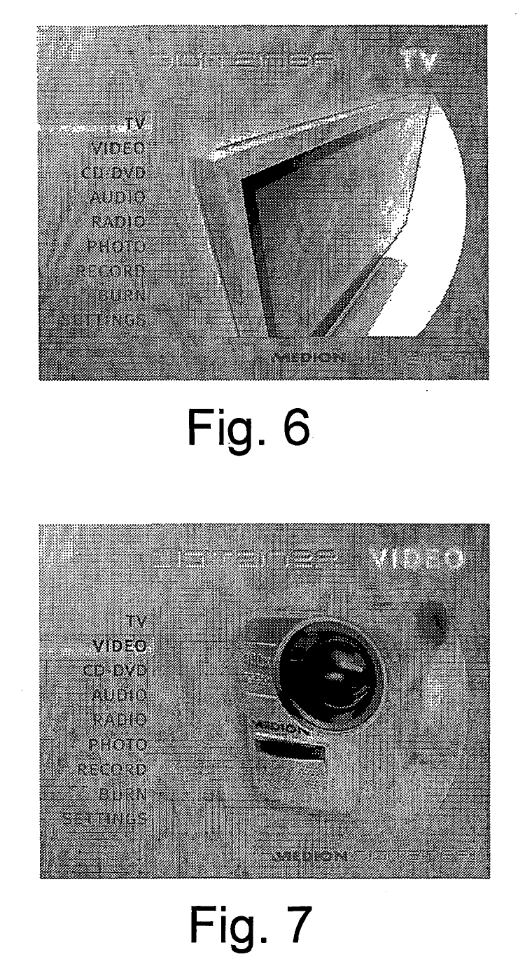

FIG. 6 to FIG. 18 show examples of the display for the user guidance according to the present invention.

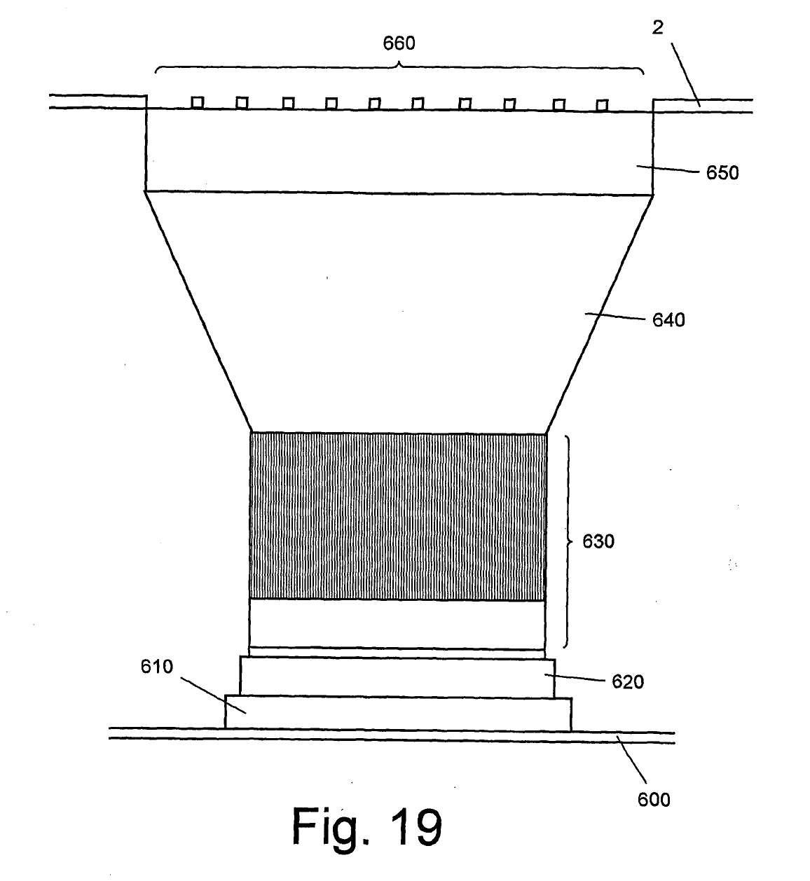

FIG. 19 shows a schematic structure of the feed of cooling air according to the present invention to the processor of the audio/video signal processing apparatus.

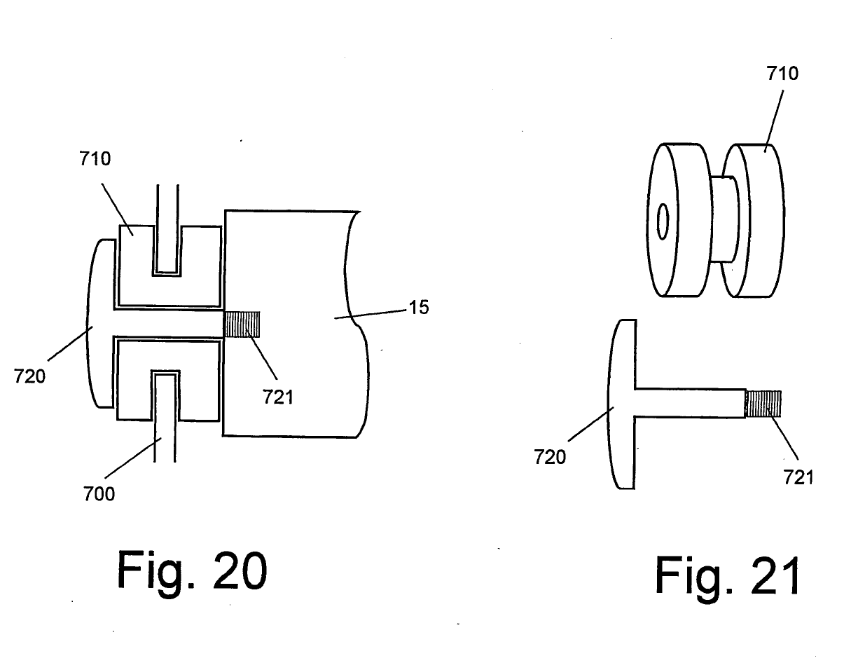

FIG. 20 shows a sectional view of the damped mounting of the mechanical drives according to the present invention in the audio/video signal processing apparatus.

FIG. 21 shows a perspective view of the damping element according to the present invention and the screw used for the mounting of the damping element.

A view of the audio/video signal processing apparatus according to the present invention is illustrated in FIG. 1. In the housing 2 of the multi-functional apparatus 1 a main board 10 is arranged with a processor 112, memory chips 20 assigned to the same and a plurality of signal processing modules 112. The signal processing modules 12 can be mounted in the slots 13.

The slots 13 preferably correspond to one of the standards for connecting plug-in cards known from personal computers, preferably the PCI standard. The abbreviation PCI stands for “Peripheral Component Interface”. This standard was introduced in 1993 and comprises a mechanical and a transfer-related component. Alternatively, the slots 13 can be formed according to the miniaturised PCI standard “MiniPCI”, as is used for example in notebooks for the connection of wireless LAN cards.

Preferably all slots 13 are formed in the same manner. Alternatively, different slots are provided which conform to different standards, for example PCI slots 13 and MiniPCI slots 13a.

Both the PCI and the MiniPCI standard each define a number of form factors for a mechanical design of the plug-in slots and the plug-in cards. Also for the electrical connections various variants are in each case defined. For details on both standards reference is made to the respective standards specification.

All modules 12 are mechanically and electrically held in the plug-in sockets of the respective slots. The modules can be in any arrangement on the individual slots due to the identical arrangement of the slots. Using the plug-in sockets, all the modules used are connected via one or more common buses, preferably the PCI bus, to the other components, in particular to the I/O communication interface 114. The PCI transmission standard defines a specified maximum transmission data rate and clock rate. The connected modules can also interchange data via the PCI bus.

The PCI bus is only described as a preferred embodiment of a common plug-in card and bus system. The modules can be mounted and contacted both via other standardised slots as well as via a proprietary standard in the housing 2.

For the reproduction, intermediate storage and/or recording of data at least one storage drive 15 is arranged in the housing 2. Both optical and also magnetic drives can be considered as storage drives. Preferably an optical storage drive is used for reading CDs and DVDs in order to then further process the read data using the processor 112 and via an appropriate audio signal processing module or video signal processing module.

The described drive or another drive is used to record data on optical storage media, i.e. the so-called “burning”. Due to the separate provision of optical storage drives for the reproduction of data and for the recording of data, each drive can be optimally rated for its application and a flexible connection of signal sources and recording media is ensured.

Additionally, a magnetic storage drive can be arranged in the housing 2. The magnetic drive can be a hard disk or a Minidisc drive. Whereas the hard disk drive is only used as an addition to a central hard disk arranged in the multi-functional apparatus, which is intended as an archiving device, the Minidisc facilitates the input of audio data via a further standardised medium.

The processor 112 executes a signal processing operation in dependence of the user controller and accordingly controls the respective module 12 and optionally the required optical drive 15. The data read from a drive are processed by the processor 112 and the respective selected module 12 and either output via an external connection 16, 17 or recorded internally on an archiving device 14 or on a storage medium in one of the optical drives 15. The archiving device 14 exhibits a standardised size so that it can be replaced flexibly by another hard disk. In this way an adaptation of the apparatus to a more or less large storage capacity requirement can be carried out to realise a configuration for example for the archiving of larger volumes of video, audio and/or photographic data.

Preferably the processor 112 is mounted on the main board 10 via a socket. Due to the socketed implementation, the processor can be flexibly adapted to the relevant configuration of the multi-functional apparatus without the main board 10 of the apparatus being modified. With particularly computationally intensive functionalities, which are integrated into the multi-functional apparatus, the processor can in a simple manner be replaced by a more powerful processor. In a corresponding way the memory chips inserted into the memory slots 20 can be similarly adapted in a simple manner to the computing power required for the computing operations of the processor 112 so that the multi-functional apparatus can be configured flexibly.

The external connections 16 and 17 facilitate the output and also the input of external signals. Preferably the signal connections 17, which are provided for a permanent connection to an external apparatus, are arranged on the back of the housing, whereas the connections 16 are located on the front of the housing 2 for the temporary connection of an apparatus.

As the interface for memory cards, a front connector module 19 with a card reader device is provided, which provides a number of plug-in slots for memory cards of various standards.

A central power supply unit 18, which supplies all components of the multi-functional apparatus with power, is arranged in the housing 2 for the voltage supply. The power supply unit 18 is preferably a standardised power supply unit which can be optimised in a simple manner depending on the configuration of the functionality of the power supply unit 18.

The power supply unit 18 is provided with a fan which provides the power supply unit with cooling air. In a special embodiment the fan in the power supply unit is realised as a fan with an electronically controlled rotational speed. The rotational speed is here preferably controlled in dependence of the temperature of the thermally critical semiconductor in the power supply unit 18.

The functional structure of the audio/video signal processing apparatus 1 according to the present invention is illustrated schematically in FIG. 2 in the form of a block diagram. The processor 112 with an archiving device 116, a man-machine interface 118, a sequential controller 115 and an I/O communication interface 114 forms the central unit 110 of the apparatus 1, which is connected via the bus 130 to the signal processing modules or to the drives 131-137. The bus 130 is preferably a PCI bus, whereby the drives are connected via an IDE bus, which is provided by the I/O communication interface. The connected modules preferably comprise a television module 131, a video signal processing module 132, an optical storage drive 133, an audio signal processing module 134, a radio module 135, a photographic module 136 and a data recording module 137.

Although the modules are preferably integrated into the multi-functional apparatus by means of special hardware, a number of functionalities can also be realised via special application software in the multi-functional apparatus. A large part of the consumer electronic functionalities can be realised alternatively via software or hardware or a combination of software and hardware. The user programs for these functionalities are preferably stored on the storage medium of the central unit 110, i.e. the hard disk drive 116. Examples of modules, which can be formed as pure software modules, are a recording module for the control of the archiving, i.e. recording and management of audio, video, and photographic files, a scheduling module for the programmed execution of recording processes and for the co-ordination of thereby occurring conflicts (for example, during a planned simultaneous execution of a number of recording processes), a time-shift module for rewinding and pausing the reproduction of a currently transmitted video or audio signal (for example, due to a private telephone interruption during the television or radio programme, so that reproduction of the transmitted programme from shortly before the interruption can be taken up again and continued with a time shift), an audio module for the management, processing and reproduction of all kinds of audio data, a video module for the management, processing and reproduction of all kinds of video data and a photographic module for the management, processing and reproduction of all kinds of still pictures.

The central unit 110 comprises the processor 112, the I/O communication interface 114, the archiving device 116, the sequential controller 115 and the man-machine interface 118. The man-machine interface is linked to an external control unit 150. The user can pass control commands to the audio/video signal processing apparatus via the control unit 150. Details of the user guidance are given below in conjunction with a detailed description of the man-machine interface 118.

The sequential controller 115 is both connected to the bus system as well as to the processor and the man-machine interface. It co-ordinates the communication and interaction between all modules and components of the multi-functional apparatus. The sequential controller can for example be realised by means of an operating system which after loading the BIOS provides predefined functions for the modules and components of the apparatus, which the modules and components can access for implementing their audio/video functionalities. The computing operations required for the implementation of the sequential controller are preferably executed by the processor 112.

The television module 131 can preferably receive and process both analogue as well as digitally transmitted television signals. Here, in each case all current standards are supported, i.e. NTSC, PAL and SECAM for analogue television and the DVB standards for digital television.

The digital television signal preferably conforms to the DVB specification. Using appropriate connections of the I/O communication interface 118, the multi-functional apparatus is not only able to receive digital television signals via a cable or antenna connection, but can also receive signals (in the DVB-S format) transmitted via satellite. With an Internet link the multi-functional apparatus can furthermore access digital content which is requested via the Internet and transmitted via satellite. In this way the audio and video contents from commercial and non-commercial providers offered over the Internet can be loaded and processed.

According to a further preferred embodiment a Pay-TV module is provided in the television module or separately from it. The Pay-TV module facilitates the reception of enciphered transmitted television programmes. Here, a technology called Conditional Access (CA) controls the access to digital television services so that the same can only be decoded by authorised users. For this purpose appropriate hardware must be installed in the respective end device which is adapted to the enciphering method used by the transmitter. Through a smart card procured by the user, the system is able to decode the transmitted data. Such a CA system can also be used for the reception of audio data.

One realisation of such a television module is for example possible with a Phillips PCI audio and video decoder with the product designation SAA7134HL. This audio and video decoder is a highly integrated single-chip decoder for the reception of analogue and digital television signals. With these chips therefore various television functions can be realised in one module, whereby the single functionalities can be addressed in each case via the central unit. Alternatively, also other chips can be used which realise the analogue and digital television, for example, separately.

VIA VT1622 conditions video output data for display on CE (Consumer Electronic) display apparatuses, i.e. for commercially available television apparatuses with SCART, composite or S-Video input. It makes signals available according to the COMPOSITE, S-Video and SCART RGB specifications.

The video module 132 facilitates archiving, management, editing and reproduction of video sequences. Video sequences, which for example have been recorded with the aid of a home video camera, can be saved via the appropriate inputs of the I/O communication interface on the hard disk of the audio/video signal processing apparatus. Alternatively, the video sequences can also be input to the apparatus for further processing using storage media such as CDs, DVDs, memory cards or magnetic tapes.

According to a preferred embodiment the multi-functional apparatus can be connected to external apparatuses via the I/O communication interface 118 and a network. For this purpose, the multi-functional apparatus is networked by wire or wireless to other apparatuses. Such a connection can be realised via a LAN or WLAN network. In contrast to conventional consumer electronic apparatuses, the multi-functional apparatus of the present invention is thus able not only to reproduce data and content stored locally in the multi-functional apparatus, but rather also such data and content which is stored on other apparatuses networked with the multi-functional apparatus. Furthermore, the apparatus can make data stored on the apparatus available to other apparatuses networked with it for reproduction.

In addition, the multi-functional apparatus can also access content, which is only obtainable via the Internet, through a modem connection. Thus, audio/video/photographic data, which are stored at a remote location, can be loaded, processed, played back or also recorded in the internal archiving device. For example, photographic archives managed by commercial providers can be recorded in one's own archive or the other archive can also be managed. The Internet access can, among others, also be formed as ISDN or ADSL access.

All input video sequences can preferably be stored and managed in the archiving device 116 of the central unit 110. In this way the user can manage his video data stock centrally and find the desired video sequence at any time. The video sequences can here be grouped in various folders as on a computer and provided with appropriate names. The sequences can be played back, edited and recorded on another medium, for example an optical storage medium. In addition, from the existing video sequences new video sequences can be composed.

The modules of the multi-functional apparatus can co-operate with one another in numerous ways. A further example of such “interactive” functionality is the reception of television signals by the television module and the further processing of the received digital television signal in the video module, for example for archiving.

The audio module manages and processes audio files in a corresponding manner. The audio files are either saved on the archiving device of the apparatus or on optical storage media such as CDs or DVDs. Alternatively audio files can also be stored on memory cards or input/output via the I/O interfaces, preferably via the USB interface. If the multi-functional apparatus is networked to another apparatus, for example via the LAN or WLAN, access can also be obtained to storage media in external apparatuses. With an Internet connection contents can also be accessed via the Internet.

The audio module can manage the user's audio data stock on the internal hard disk as an archiving device of the multi-functional apparatus. In this manner each audio file can be quickly recalled. The audio files can be copied between all storage media—provided this is permissible depending on existing copy protection mechanisms—so that desired titles can be grouped together, for example on a new CD or a memory card for a portable reproduction apparatus.

The coding of digital audio and video data can for example be realised with the aid of the Phillips integrated circuit SAA6752HS. This semiconductor integrated circuit facilitates audio and video recording according to the coding standards MPEG-2 Video and MPEG-Audio/AC3-Audio.

This chip combines computing operations of the audio and the video modules into one chip. The various functions are in each case separately activated depending on the desired application of the central unit 110. For the person skilled in the art it is obvious that any number of functions can be combined in a module 12, whereby the individual application operations can each be individually recalled by the central unit depending on the consumer electronic apparatus functionality desired by the user.

A special digital audio coding/decoding chip is the integrated circuit CMI 9761 from C Media Electronics, Inc. This chip realises a six-channel audio coder and decoder with which an audio module can be realised.

The radio module 135 facilitates the analogue and digital radio reception of radio signals transmitted via terrestrial, satellite or cable means. Preferably the radio module only plays back radio programmes transmitted via FM. Additionally however radio programmes also transmitted via AM can be played back. The module can be realised separately or together with the television module.

Also with separate realisation of the radio module and the television module, the central unit can access radio programme forecasts which are transmitted via teletext or videotext. The radio module itself cannot access the content of videotext or teletext, because this information is only obtainable via the television module. This functionality is therefore offered to the user via an interaction between various modules and in fact for example a programme preview is integrated into the radio menu interface for the user and can be recalled from the same.

Additionally, information transmitted in the radio band can be acquired via special service channels and be made available to the user. For this purpose an RDS chip, which can be optionally employed, is integrated into the radio module or into the combined radio/television module. This chip decodes the RDS information transmitted with the radio signal so that it can be displayed to the user. Alternatively, the RDS module is provided separately from a radio module and/or a television module to extract and display RDS information.

The radio module 135 can be realised independently of a television module, for example with the Phillips radio module FM1216ME of the MK3 family. The Phillips FM1216ME of the MK3 family is a TV FM tuner. It is needed for both TV as well as for FM radio.

Similar to the video module 132, which facilitates the management and processing of video sequences, and the audio module 134, the photographic module 136 provides a number of operations for the management, editing and archiving of still pictures. Preferably it can be used by the user of a digital camera to manage photographs that have been taken. The user inputs the photographs that have been taken via an appropriate interface, e.g. a USB interface of the I/O communication interface or via memory cards of the audio/video signal processing apparatus. The photographs can in turn be saved in individual folders in a simple manner as on a computer, provided with supplementary text or edited. For the production of paper pictures the corresponding information can be optionally directly assigned to the photograph as a processing file and recorded on a storage medium, for example a memory card, for passing to a laboratory. Furthermore the apparatus has the possibility of printing out photographs on a suitable printer which is connected directly to the multi-functional apparatus, via the interfaces, for example via the USB interface.

In addition, photographs can be grouped together with the photographic module 136 to form sequences which can be played back one by one or in an automatic manner as a “slide show” on a monitor or television apparatus that can be connected.

Both the photographic module as well as the video and audio module are set up for the processing of video and audio signals in all conventional formats.

A separate module 133 contains an optical storage medium, in particular a CD and DVD drive. The module 133, together with other modules, handles all tasks, which conventionally are covered by a separate CD or DVD player.

In a further module 137 audio and video data can be recorded on an optical storage medium, such as a CD or a DVD rewritable device. Generally this functionality is designated as “CD/DVD burner”.

The optical drives used in the multi-functional apparatus conform to a standardised installation size with standardised connections so that they can be interchanged in any manner for optimum adaptation to the apparatus functionality.

The central unit 110 contains the processor 112, the I/O communication interface 114, the archiving device 16, the sequence control 115 and the man-machine interface 118. The processor 112 is the central processing unit of the audio/video signal processing apparatus. The processor handles all arising computing operations, also the computing tasks passed to it from the individual modules 131-137 via the bus 130. For example, the processor handles coding and decoding tasks for audio and video signals, provided these computing operations are not dealt with by the modules themselves.

According to a preferred embodiment all audio/video computing operations arising in the multi-functional apparatus are carried out by the processor 112. The processor 112 is thus the sole, central processing unit for all audio and video computing operations. Preferably the processor and the sequence control are arranged such that a plurality of different functions can be processed simultaneously. For example, during the reproduction of a television or radio programme, a recording or an archiving of this programme or another audio or video signal can be carried out.

The processor 112 can be realised with any powerful processor of a conventional personal computer. For example, the Intel Celeron processor can be used for this purpose.

Connections for the input and output of data are provided by the I/O communication interface 114, i.e. the I/O communication interface comprises all interfaces of the multi-functional apparatus. Radio and television signals can be input via appropriate antenna connections, audio and video signals of other consumer electronic apparatuses via the corresponding standardised connections, for example SCART connections for a television apparatus, composite or S-Video for a video recorder and Analogue Audio In/Out for analogue audio apparatuses. Additionally, the I/O communication interface 114 supports all current memory card standards such as for example the “Memory Stick”, “MultiMedia Card”, “SD Card”, “CompactFlash Card”, “SmartMedia Card” and USB Stick. Memory cards are interchangeable, rewritable, non-volatile storage media. The storage takes place in flash memory chips in the card.

Memory sticks are currently mainly used in Sony devices, but there in a plurality of different apparatuses. MultiMedia cards are used in a large number of MP3 players and mobile phones. SD cards are these days preferably used in organisers, MP3 players and mobile phones, whereas CompactFlash cards are used in a large number of cameras. The USB stick is inserted into a free USB connection of the I/O communication interface and is immediately available as an additional drive for the recording or reading of data.

Video signals can be directly recorded or transferred in a simple manner from a video camera via standardised bus connections, for example for the IEEE 1394 (Firewire) or USB bus. The USB (Universal Serial Bus) is a standard for the connection of external devices via a standardised plug with a high data transfer rate. Additionally or alternatively, an interface according to the universal standard RS232 can also be provided.

In order to network the multi-functional apparatus also to external devices a network connection is preferably provided for wired LAN networks such as Ethernet 10/100/1000 or wireless WLAN networks, such as 802.11b/g. The multi-functional apparatus can also be connected to the Internet via a modem, an ISDN or ADSL connection.

The processed signals are output via appropriate video and audio connections. Preferably at least one television apparatus or video monitor can be connected for the output of video signals. The video output occurs in this respect as a television signal (composite, SCART RGB or S-Video signal) or for computer monitors as a VGA signal. Appropriate signal conversion integrated circuits are preferably arranged in the interface device 118.

The audio signals can also be played back via a connected television apparatus. In addition, the audio signals can be input to a separate hifi system for reproduction over its loudspeakers. In addition audio signals can be directly output to loudspeakers if the loudspeakers are the so-called “active loudspeakers” or to passive loudspeakers if a suitable amplifier is provided as a separate module or as a constituent part of one of the other modules in the multi-functional apparatus.

In a particular embodiment the audio/video signal processing apparatus comprises a headphone connection or/and a module for operating wireless headphones, so that no direct cable connection is necessary between the apparatus and the headphones. With the aid of such a module for a wireless headphone connection, either based on infrared or radio, the conventional separate transmitter module can be integrated into the multi-functional apparatus of the present invention.

The I/O communication interface is preferably constructed in a modular manner so that the provided input and output connections can be configured as required. Some of the components of the I/O communication interface are here permanently soldered on the main board. Video output, audio input and output are components which are needed in any variant and are always part of the “basic equipment”. These components can—if required—be switched off and/or supplemented by new components. The multi-functional apparatus can thus be equipped such that new components can also be inserted into the module slots and in this way can be integrated into the I/O communication interface.

The present invention is not restricted to the previously mentioned modules and their specific composition. Any composition of modules and also a large number of modules previously not explicitly addressed can be integrated into the multi-functional apparatus via the slots provided in the housing.

The man-machine interface 118 facilitates the user's interactive control of the multi-functional apparatus according to the invention. For this purpose the man-machine interface 118 is connected to a control unit 150, via which the user can enter his control commands. The control unit 150 can be permanently connected to the apparatus, but is preferably formed as a wireless remote control unit.

The structure of the man-machine interface is given in detail in FIG. 3. The man-machine interface 118 contains a menu guidance unit 310, an on-screen display unit 320, a radio receiver unit 340, a converter 350 and a status register 370.

The menu guidance unit 310 produces the data content to be displayed in order to interactively display to the user the currently applicable control selection possibilities. The menu options offered to the user depend on the respective configuration of the multi-functional apparatus, the current operational state and preceding selection commands by the user. The menu guidance is explained in detail in the following in conjunction with FIGS. 6 to 18.

The content selected by the menu guidance unit 310 is passed to an on-screen display unit 320 which generates a video signal from the content to be displayed. The display signal generated by the on-screen display unit 320 is passed to the appropriate connections (or the appropriate video output components) of the I/O communication interface 114 for output to a television apparatus or to a video monitor. A display unit 330, in particular a television apparatus or a monitor, connected to the multi-functional apparatus displays to the user the menu options available to him at the current navigational level.

Whereas conventionally a user must become accustomed to a large number of keys on a remote control unit or must even operate a keyboard with supplementary pointer control, the menu guidance according to the present invention manages without a tedious accustomisation phase. The basic principle of the user guidance according to the present invention is explained in the following with reference to FIGS. 4 and 5. Detailed examples are then described based on FIGS. 6 to 18.

A schematic illustration of a menu image generated by the on-screen display unit 320 is given in FIG. 4. The user can select a certain command for the control of the multi-functional apparatus via the menu points A to E. Depending on the command, either the user is shown an appropriate further menu or a selected function is executed. Using the key designated “Back”, the user can return to the next higher navigational level.

The user guidance with the aid of menus facilitates an intuitive navigation to the desired control command without a complicated explanation of the control of the apparatus being necessary. Whereas conventional apparatuses provide a confusing variety of keys, selection schemes are offered to the user in the same manner for all conventional consumer electronic apparatuses to be emulated by the multi-functional apparatus. Irrespective of the basic functionality, the user can cope in a simple manner with the respective apparatus functionality.

The user makes the selection of the respectively displayed menu point via the remote control unit 150. The remote control unit 150 is preferably provided with scroll keys or a rotating wheel appropriate to the control options offered to the user in a simple manner. One example of an arrangement of the control section of the remote control unit 150 is given in FIG. 5.

The control section 500 illustrated in FIG. 5 contains a rotating wheel 510. Optionally, two further keys 520 and 530 are provided. The key 520 enables a return to the next higher navigational level. The key 530 facilitates the return to the starting menu. Alternatively, suitable navigation options can also be made available to the user via the display signal.

The central element of the remote control unit is the rotating wheel 510. By rotating the wheel up and down the user can select in each case one of the displayed menu points. The initially provisionally made selection is highlighted for the user by appropriate marking or emphasis in the display. This option is selected by pressing the rotating wheel 510 so that either the navigational level with further options located below or the selected operation is carried out. Alternatively, the activation of a selection can also be realised in another simple way, for example by a key which is operated separately.

The special advantage of a control section arranged in this way is that it can be operated in a simple manner with one finger, preferably with the thumb. Without having to look at the remote control unit, the user can control the multi-functional apparatus in a simple manner in contrast to conventional remote control units. There is no longer any need to give explanations on the use of the keys provided on a remote control unit.

Preferably the remote control unit is configured as a radio remote control unit. In contrast to conventional remote control units based on infrared, the radio remote control unit needs neither line of sight contact to the apparatus, nor must the apparatus be sited such that the receiving sensor senses a large part of the room to facilitate free movement by the user in the room. In contrast to conventional consumer electronic apparatuses, the audio/video signal processing apparatus can therefore also be sited in a concealed position. In addition, during operation the radio remote control unit does not require the user to aim with the remote control unit at the apparatus to be controlled when pressing a key.

The man-machine interface 118 comprises an appropriate radio receiver unit 340, which receives the user's selection signals from the remote control unit 150. These signals are converted into a corresponding module control command in a converter 350. To achieve this, a corresponding control command, which is passed on to the relevant module, is generated according to the user's selection in dependence of the currently activated module saved in a status register 370. For the case where the selected navigational level requires a further selection by the user, the selection made is passed to the menu guidance unit 310.

After switching on the multi-functional apparatus the user is initially shown the uppermost navigational level. In this level the user can select an option from a menu offering various consumer electronic functionalities, whereby each option respectively corresponds essentially to a conventional consumer electronic apparatus.

Examples of the uppermost navigational level, which the user can always reach by pressing the key “Menu” 530, are illustrated in FIGS. 6 and 7. This level is activated by pressing the key 530 also during the execution of an application operation. The user can thus very quickly change a currently selected application of the multi-functional apparatus. Through a logic control, with incompatibility of the selected application operations, the previous application is automatically switched off and the new one activated. Various applications can however also be activated absolutely simultaneously. For example, a recording of a current television programme on the hard disk can be carried out with another operation, for example a reproduction of music or the management of audio or video files.

In FIGS. 6 and 7 examples are shown of how the user can select between the menu options displayed one below the other. Whereas in FIG. 6 the menu pointer is located on “Television”, in FIG. 7 it is set to “Video”. By pressing the rotating wheel 510 on the remote control unit, the respectively set option is selected and a further menu image for activating the consumer apparatus to be simulated by the multi-functional apparatus is displayed.

FIG. 8 shows an overview of the first navigational level after selecting the application “Television”. The user can for example select between the options “Recorded television programmes”, “Programme overview”, “Electronic programme guide” and “Videotext”.

If possible, additional information is shown to the user depending on the currently marked menu point. This information can give the user a preview of the operation or content of the relevant menu point. Alternatively, the additional information for each menu point can be simultaneously displayed in each display image to show the user the signal source, or other feature, available for each option.

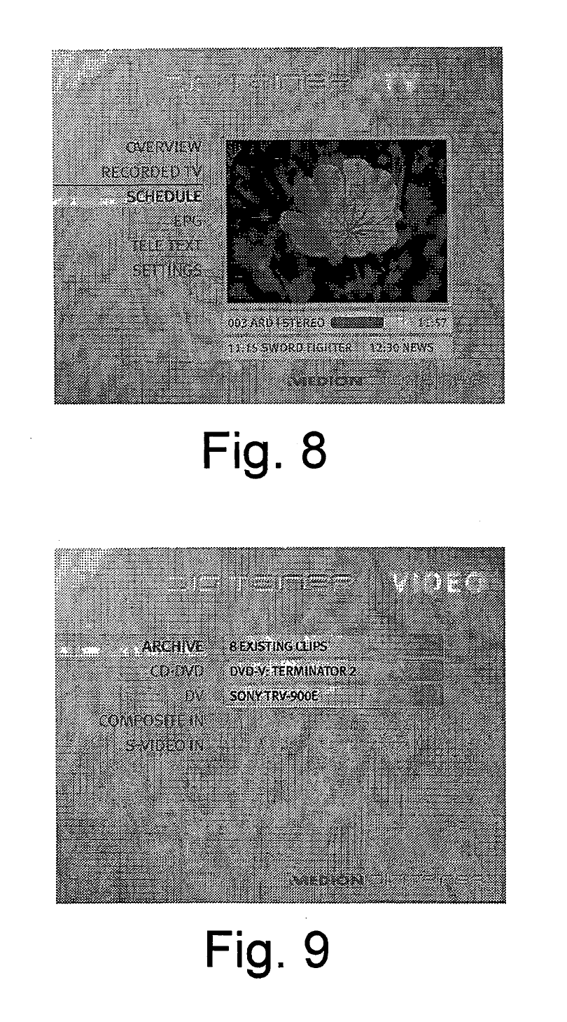

Examples of menus after selecting the application “Video” are illustrated in FIGS. 9 to 13. The first navigational level after the selection of the application “Video” is displayed in FIG. 9. The user receives an overview of the possible sources for video data, namely archived video data (“Archive”), CD/DVD, camcorder (“DV”), television signal (“Composite in”) and S-Video input.

As long as the selection pointer is located on a menu point without this menu point being actually selected, the user is shown again additional information about this menu point (or about all menu points). As is illustrated in FIG. 9, the user has currently saved eight video clips in the archiving device. Additionally in this case, the user is shown irrespective of the position of the selection pointer additional information about the optical storage drive (“CD/DVD”) and about the connection of a camcorder. According to the illustrated example, a video DVD with the title “Terminator 2” is inserted into the DVD drive and a camcorder of the type “Sony TRF 900E” is connected to the DV connection.

In a corresponding manner data can be accessed which is located on an apparatus which is connected via a network or which can be reached via the Internet.

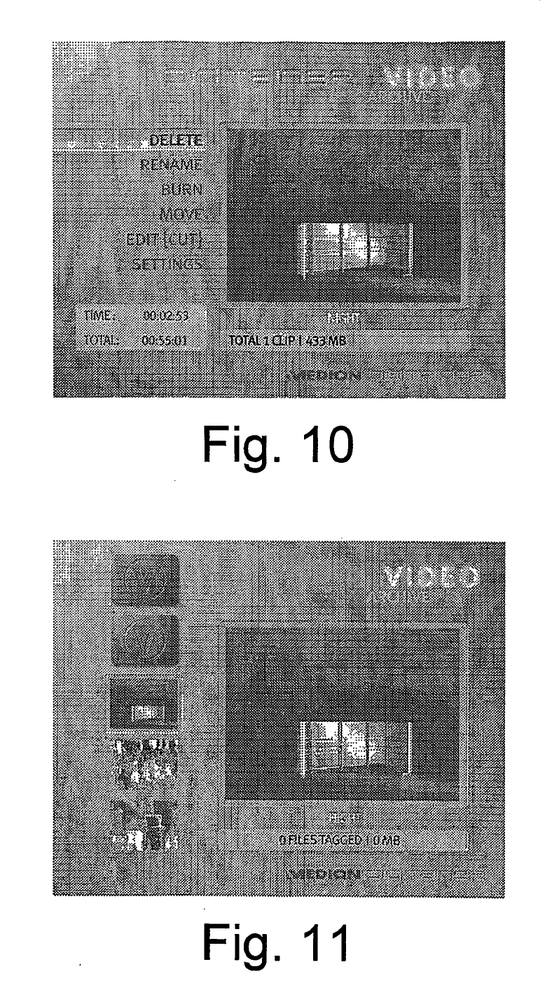

To simplify the navigation for the user, he is shown each essential navigational step visually, in particular the respective currently selected navigational level. Once the user has left the first navigational level, the current navigational situation is shown, in the illustrated example at the top right, in the displayed picture, namely “TV” (FIG. 8) or “Video” (FIG. 9). If the user now selects the menu point “Archive”, then, as shown in FIG. 10, the term “Archive” is superimposed in addition to the term “Video”. The user is now shown the operations available for the archive, such as deleting a file (“Delete”), renaming a file (“Rename”), moving a file (“Move”) or editing/cutting a file.

With the example shown in FIG. 10 the selection pointer is located on “Delete”. Adjacent, the user is shown simultaneously an extract of the selected video sequence and further details such as title and size of the file to be deleted.

FIG. 11 shows a menu screen for selecting a video sequence on which an editing operation is to be performed. A preview shows an extract of the selected video sequence.

In FIG. 12 a menu screen is shown in which the user can give a video sequence a new name. Instead of a vertical arrangement of the selected characters for renaming the file name of the video sequence, in this case a horizontal arrangement of the letters, figures and special characters is chosen. By turning the rotating wheel 510, the user moves sequentially through the individual lines of the characters from “A” at the start of the first line to “*” at the end of the last line. The respectively highlighted character is accepted into the new file name by pressing the selection wheel.

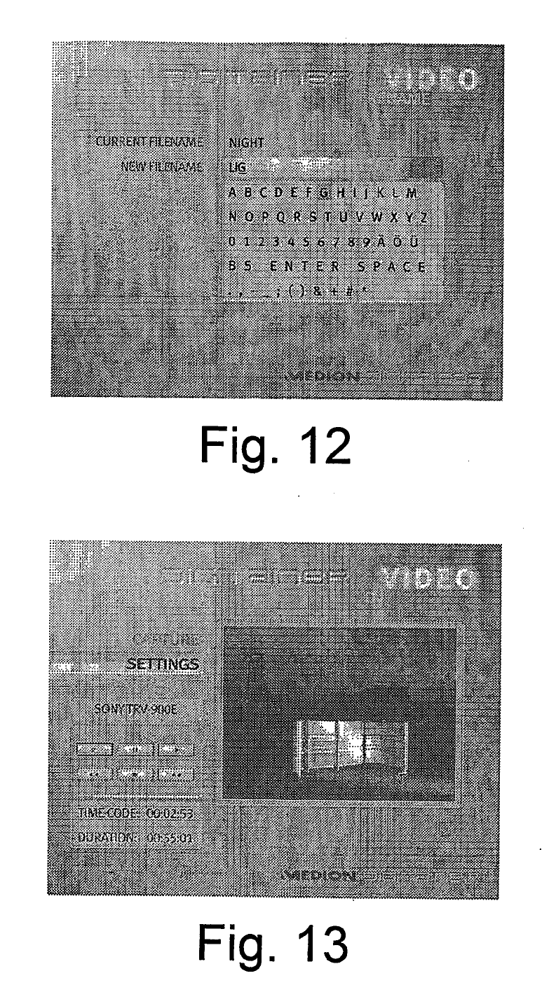

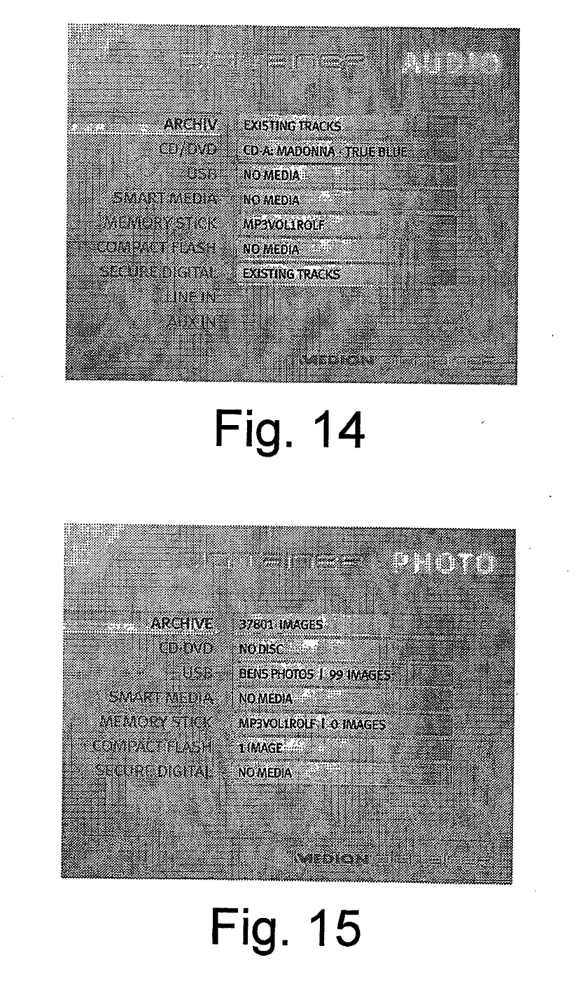

FIG. 13 shows an example of the controller of a camcorder connected to the multi-functional apparatus, in this case type Sony TRV-900E. For the control of the apparatus a control panel is superimposed, the keys of which are selected and activated via the rotating wheel.

In FIGS. 14 to 18 further examples of other functional sections of the apparatus are given. FIG. 14 shows an example of the management of audio data. Audio data can be archived on the hard disk, passed to a CD/DVD, a USB interface or memory cards. With the display form illustrated in FIG. 14 it is stated at each menu point whether files are present and if so, which. Such additional details simplify at a glance the selection of the desired menu point for the user.

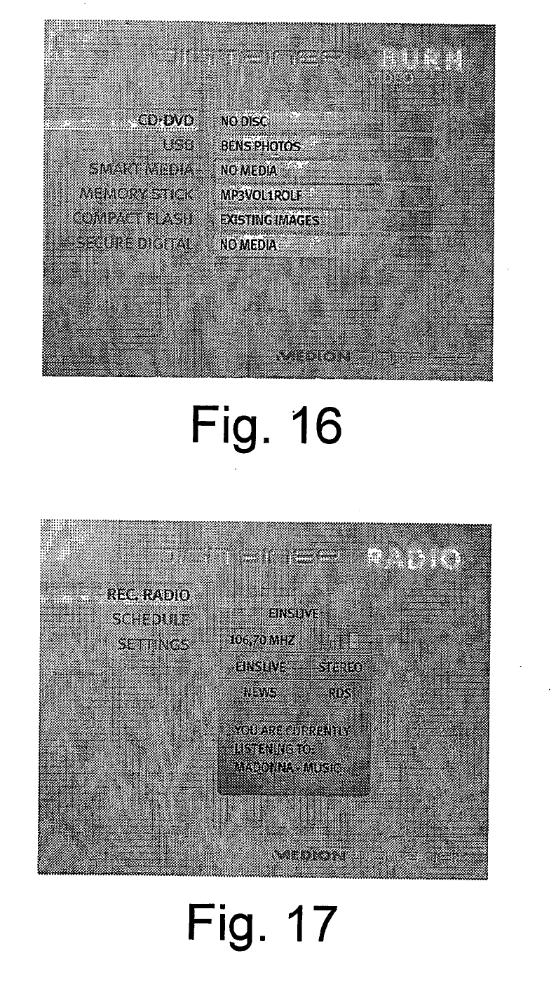

A similar selection as for the management of audio data and video data is offered to the user during the management and editing of his photographic files, as illustrated in FIG. 15.

FIG. 16 shows the following menu level with the selected recording medium after the selection of the application “Record” from “Video”. Here, the user is offered, among other things, the menu points “Optical storage medium”, USB interface and various memory cards. The user is here shown whether a storage medium is inserted and which files are already present on this storage medium.

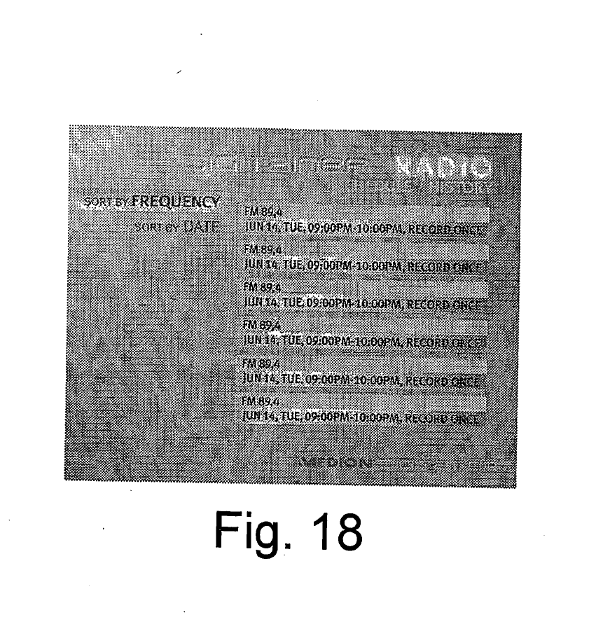

FIGS. 17 and 18 refer to the display of user data for the application “Radio”. In FIG. 17 the menu point “Record radio” is selected. The user is simultaneously shown the currently received radio programme with all available additional information. FIG. 18 gives the user an overview of the radio programmes he has last recorded. Here, the user is shown simultaneously details of the individual files, such as transmission frequency, the transmission date and time.

The menu guidance represents a uniform and intuitive user guidance for the simulated consumer electronic apparatus in order to arrange the operation of the multi-functional apparatus in a particularly simple and user-friendly manner. Additional measures result in the multi-functional apparatus also operating particularly quietly during the implementation of a selected application, so that the perception of the replayed audio or video data is not impaired.

FIG. 19 shows a particular internal arrangement of the multi-functional apparatus for cooling the processor 112. The processor 620 is mounted on a board 600 via a CPU socket 610. A heat sink 630 is mounted on the CPU 620. The heat sink is preferably made of aluminium or copper. A processor fan 650 feeds a constant air flow to the heat sink via an air duct 640. The air duct is connected to an inlet opening 660 for external air provided in the housing 2. In this way the heat sink is continually fed with external air. The ambient air around the apparatus is generally significantly cooler than the air which is located inside of the apparatus and in fact by about 10° C. In this way the processor fan 650 can be operated at a lower rotational speed so that its generated noise is correspondingly lower.

Additionally, the air duct 640 is formed conically, and in fact such that its cross-section in the direction of the inlet opening 660 increases in the housing 2. The processor fan 650 is positioned directly behind the housing opening 660 and exhibits therefore a significantly larger cross-section than the heat sink 630. Due to this arrangement of the air duct 640 and the processor fan 650, the rotational speed of the processor fan can be further reduced and the noise generated accordingly reduced.

There is an electronic speed control for the fan. The command variable is the CPU chip temperature. The fan control ensures that the fan only runs as fast as is necessary. It ensures that the CPU is not operated outside the limits of its thermal specification and also the minimum possible noise disturbance occurs.

An arrangement corresponding to the processor cooling is provided for the cooling of the power supply unit 18. Preferably external air is also fed to the power supply unit 18 via a conically shaped air duct. The fan for the power supply unit can also always be operated at the minimum possible speed using an electronic speed controller so that the noise emissions from the fan are always at the achievable minimum.

A further measure for the reduction of noise emissions is shown in FIGS. 20 and 21. Vibrations of the motorised drives 15 of the multi-functional apparatus may be noticeable as disturbing noise emissions via the housing 2 acting as a resonating body.

In order to suppress the transfer of vibrations from the motorised drives to the housing, the drives are mounted in the housing via damping elements. For this purpose the drive 15 inserted in the installation tray 700 is fixed using damping means 710 in the installation tray. The damping means 710 are formed such that a fixed mechanical connection between the mounting means 720 and the installation tray 700 is suppressed. The mounting arrangement is shown in detail in FIG. 21.

The screw 720 is firmly joined to the mechanical drive 15 by a thread 721. At the same time the screw 720 is mounted via the damping element 710 in a vibration suppressing manner in the drive receptacle 700. With a mechanical drive 15 damped in this way the risk of disturbing noise emissions due to the transfer of vibrations onto the housing 2 is minimised.

Of course, a plurality of alternative mountings are possible which avoid a firm mechanical connection between the drive and the housing, whereby a damping element is always used. Only one arrangement is shown as an example in FIG. 20. Also the specific mechanical mounting of the drive in the installation tray can occur in a large number of variants, for example also via a plastic rail attached to the drive. The rail is preferably fitted to the drive housing via damping elements.

Summarising, the present invention relates to an audio/video signal processing apparatus, which in a compact manner integrates a number of conventional consumer electronic apparatus into one single device. In achieving this, the computing power of a central processor is made available to all modules of the audio/video signal processing apparatus. The approach according to the present invention facilitates the combination of a wide range of different consumer electronic functionalities into one apparatus. Due to the integration of a plurality of apparatuses or applications into one housing with common usage of different storage media, new possible uses are opened up for the first time for a plurality of the applications. Due to the uniform application of storage media, central processing unit, electrical communication interface and the user interface, the hardware complexity can be minimised and the user friendliness can be significantly improved by the use of a uniform user interface. The modular structure of the application functions facilitates an economical and flexible adaptation to new technologies and new standards. In addition the apparatus configuration can be adapted in a simple manner to local circumstances.

1. An audio/video signal processing apparatus for a plurality of different audio and/or video signal processing operations with a housing, a central unit arranged in the housing, a plurality of signal processing modules provided in the housing for audio and/or video signal processing operations and a control unit, wherein the central unit comprises:
a processor for the execution of computing operations for an audio and/or video signal processing operation in accordance with an activated signal processing module of the plurality of signal processing modules,
an archiving device for storing audio and video signals,
a man-machine interface with a device for generating a display signal for a common visual user guidance of the audio and/or video signal processing operations of the plurality of signal processing modules, a device for detecting user operations from the control unit for the control of the audio and/or video signal processing and a device (350) for the respective control of one of the signal processing modules, and
an I/O communication interface for receiving audio and/or video signals to be processed and for the output of audio and/or video signals including the display signal for the visual user guidance on a display device which can be connected to the I/O communication interface.

2. An audio/video signal processing apparatus according to claim 1, wherein the archiving device is a hard disk drive.

3. An audio/video signal processing apparatus according to claim 1, wherein the I/O communication interface comprises connections for at least one of the interface standards PCI, USB, Firewire or RS232 for a wireless and/or wire-connected LAN/WLAN network and/or for the Internet an analogue modem, an ISDN connection or an ADSL connection.

4. An audio/video signal processing apparatus according to claim 1, wherein the I/O communication interface is of modular construction.

5. An audio/video signal processing apparatus according to claim 3, wherein connections of the I/O communication interface are arranged for a permanent apparatus connection on the back of the housing and connections of the I/O communication interface are arranged for a temporary apparatus connection on the front of the housing.

6. An audio/video signal processing apparatus according to claim 1, wherein the I/O communication interface contains at least one output connection for a television apparatus or a monitor for the display of a video signal.

7. An audio/video signal processing apparatus according to claims 1, wherein the device for the generation of a display signal is an on-screen display unit.

8. An audio/video signal processing apparatus according to claim 7, wherein the display signal for the visual user guidance displays a list of menu options.

9. An audio/video signal processing apparatus according to claim 8, wherein after powering up a menu for the selection of an audio/video signal processing functionality is displayed.

10. An audio/video signal processing apparatus according to claim 8, wherein the control unit is a selection device for the selection of one of the displayed menu options.

11. An audio/video signal processing apparatus according to claim 1, wherein the control unit is a remote control unit, in particular a radio remote control unit.

12. An audio/video signal processing apparatus according to claim 11, wherein the remote control unit contains a manually operable rotating wheel for the selection of one of the displayed menu options.

13. An audio/video signal processing apparatus according to claim 11, wherein the remote control unit contains manually operable scroll keys.

14. An audio/video signal processing apparatus according to claim 8, wherein the visual user guidance for all signal processing modules is performed via menus.

15. An audio/video signal processing apparatus according to claim 1, wherein the man-machine interface contains a storage device for storing the status information needed for the user guidance and operation in accordance with the signal processing modules provided in the housing.

16. An audio/video signal processing apparatus according to claim 15, wherein the man-machine interface converts signals received by the control unit in accordance with the respectively active signal processing module into module-specific control commands for the respectively active signal processing module.

17. An audio/video signal processing apparatus according to claim 1, wherein the status information specifies the respectively active signal processing module.

18. An audio/video signal processing apparatus according to claim 1, wherein the processor of the central unit executes all the audio/video computing operations.

19. An audio/video signal processing apparatus according to claims 1, wherein the processor of the central unit simultaneously processes a plurality of different audio/video computing operations.

20. An audio/video signal processing apparatus according to any claim 1, which also contains a fan for passing cooling air over a component of the audio/video signal processing apparatus.

21. An audio/video signal processing apparatus according to claim 20, wherein the fan is a processor fan for passing cooling air over the processor.

22. An audio/video signal processing apparatus according to claim 20, wherein the fan is a power supply unit fan for passing cooling air over the power supply unit.

23. An audio/video signal processing apparatus according to claim 20, wherein the fan is arranged directly on the housing.

24. An audio/video signal processing apparatus according to claim 23, which also comprises an air duct for the connection of the fan to the housing for the feeding of external air to the component to be cooled.

25. An audio/video signal processing apparatus according to claim 24, wherein the air duct exhibits a conical shape.

26. An audio/video signal processing apparatus according to claim 21, wherein the processor fan exhibits a larger cross-section than the processor.

27. An audio/video signal processing apparatus according to claim 26, wherein the fan exhibits a cross-section larger than 45×45 mm.

28. An audio/video signal processing apparatus according to claim 20, wherein the fan is operated with a rotational speed slower than 3000 rpm.

29. An audio/video signal processing apparatus according to claim 20, wherein the rotational speed of the fan is controlled in accordance with the temperature of the component to be cooled, in particular of the processor or of the power supply unit.

30. An audio/video signal processing apparatus according to claim 1, wherein mechanical drives provided in the housing are mounted via damping elements.

31. An audio/video signal processing apparatus according to claim 30, wherein the mechanical drive is an optical drive, in particular a DVD drive or a CD drive or a hard disk drive.

32. An audio/video signal processing apparatus according to claim 30, wherein the damping elements are made of rubber.

33. An audio/video signal processing apparatus according to any claim 30, wherein the mechanical drive can be inserted into the housing via a plastic rail and the plastic rail is mounted on the mechanical drive via rubber buffers.

34. An audio/video signal processing apparatus according to claim 1, wherein the housing comprises a plurality of slots for the insertion of signal processing modules in the form of plug-in cards and a plurality of slide-in slots for the insertion of mechanical drives.

35. An audio/video signal processing apparatus according to claim 34, wherein the plug-in and slide-in slots each conform to a standard form factor.

36. An audio/video signal processing apparatus according to claim 35, wherein the standard form factor for signal processing modules is the PCI standard, the Mini PCI standard and/or the AGP standard.

37. An audio/video signal processing apparatus according to claim 35, wherein the standard form factor for mechanical drives is the 5¼ inch standard, the 3.5″ standard, the 3″ standard or the 2.5″ standard.

38. An audio/video signal processing apparatus according to claims 1, wherein a signal processing module emulates the audio and/or video signal application of a conventional audio or video apparatus.

39. An audio/video signal processing apparatus according to claim 1, wherein the signal processing modules arranged in the housing comprise a television module, a video module, a CD/DVD module, an audio module, a radio module, a photographic module and/or a recording module.

40. An audio/video signal processing apparatus according to claim 39, wherein the television module is an analogue television module and/or a digital television module.

41. An audio/video signal processing apparatus according to claim 40, wherein the television module is an analogue television module for the reception of television signals according to the NTSC, PAL and/or SECAM standard.

42. An audio/video signal processing apparatus according to claim 40, wherein the television module is a digital television module for the reception of television signals according to the DVB standard.

43. An audio/video signal processing apparatus according to claim 40, wherein the television module is configured for the reception of television signals transmitted via satellite, cable and/or terrestrially.

44. An audio/video signal processing apparatus according to claim 40, wherein the television module is configured for the processing of HDTV signals.

45. An audio/video signal processing apparatus according to claim 39, wherein the radio module is an analogue and/or digital radio module.

46. An audio/video signal processing apparatus according to claim 45, wherein the radio module is set up for the processing of radio signals transmitted according to the DAB standard.

47. An audio/video signal processing apparatus according to claims 39, wherein the recording module allows a recording of data on an optical storage medium, in particular a CD, DVD or HD-DVD.

48. An audio/video signal processing apparatus according to claim 47, wherein the recording module is able to display data recorded on the optical storage medium and is also able to record data on the optical storage medium.

49. An audio/video signal processing apparatus according to claims 39, wherein the recording module is a magnetic storage drive, in particular a hard disk drive, a Minidisc drive or a flash memory drive.

50. An audio/video signal processing apparatus according to claim 39, wherein the video module is set up for the decoding of coded audio and/or video data and/or for the coding of audio and/or video data.

51. An audio/video signal processing apparatus according to claim 50, wherein the video module is set up for the processing of video signals according to the coding standard MPEG, DVC-Pro, H.26x., JPEG, Motion-JPEG, and/or JPEG-2000 and/or for the processing of audio signals according to the standard MP3, WMA, AC3 and/or AVI.

52. An audio/video signal processing apparatus according to claim 39, wherein the audio module is set up for the decoding of coded audio data and/or for the coding of audio data.

53. An audio/video signal processing apparatus according to claim 52, wherein the audio module is set up for the processing of audio signals according to one of the standards MP3, WMA, AC3, and/or AVI.

54. An audio/video signal processing apparatus according to claim 39, wherein the video module and/or the audio module is set up for the archiving of video and/or audio data.

55. An audio/video signal processing apparatus according to claims 39, wherein the photographic module is able to code, edit and archive picture data.

56. An audio/video signal processing apparatus according to claims 1, wherein the I/O communication interface comprises an output connection for consumer electronic apparatuses, in particular a SCART, composite and/or S-Video connection.
